(19) United States
(12) Patent Application Publication
(10) Pub. No.: US 2008/0006955 A1
(43) Pub. Date: Jan. 10, 2008

(54) METHOD AND APPARATUS FOR MOLD COMPONENT LOCKING USING ACTIVE MATERIAL ELEMENTS

(75) Inventor: Joachim Johannes NIEWELS, Thornton (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: HUSKY INJECTION MOLDING SYSTEMS LTD., Bolton (CA)

(21) Appl. No.: 11/773,917

(22) Filed: Jul. 5, 2007

Related U.S. Application Data
(62) Division of application No. 10/830,485, filed on Apr. 23, 2004.

(51) Int. Cl. B29C 45/80

(52) U.S. Cl. 264/40.5

(57) ABSTRACT

Method and apparatus for applying a force to a portion of a surface of a mold component are provided. An injection mold has a core insert, a side acting core insert, and a piezoceramic actuator. The amount of force needed for sealing a surface of said side acting core insert to a portion of a surface of said core insert is determined, and a piezoceramic actuator is actuated so as to supply the force to seal the side acting core insert against the core insert during a molding operation. A piezo-ceramic sensor may be provided to sense a force between the side acting core insert and the core insert, and to generate corresponding sense signals. Wiring structure is coupled to the piezo-ceramic sensor and is configured to carry the sense signals.

The present application is a divisional of U.S. patent application Ser. No. 10/830,485, filed Apr. 23, 2004, the entire contents of which are hereby incorporated herein by reference.

### BACKGROUND OF THE INVENTION

1. Field of the Invention

The present invention relates to a method and apparatus in which active material elements are used in injection molding machine equipment (e.g., insert stacks), in order to exert a force on one or more side core inserts, urging them against the core side wall of an injection mold, thereby improving the quality of the molded article, and the life of the mold components. “Active materials” are a family of shape altering materials such as piezoceramics, electrostrictors, magnetostrictors, shape memory alloys and the like. In the present invention, they are used to adjust the positions of and forces exerted by side core inserts, thereby improving the quality of the molded article, and improving resin sealing. The active material elements may also be used as sensors.

2. Related Art

Active materials are characterized as transducers that can convert one form of energy to another. For example, a piezoactuator (or motor) converts input electrical energy to mechanical energy causing a dimensional change in the element, whereas a piezo sensor (or generator) converts mechanical energy—a change in the dimensional shape of the element—into electrical energy. One example of a piezoceramic transducer is shown in U.S. Pat. No. 5,237,238 to Berghaus. One supplier of piezo actuators is Marco Systemanalyse und Entwicklung GmbH, Hans-Böckler-Str. 2, D-85221 Dachau, Germany, and their advertising literature and website illustrate such devices. Typically an application of 1,000 volt potential to a piezoceramic insert will cause it to “grow” approximately 0.0015″/inch (0.15%) in thickness. Another supplier, Midé Technology Corporation of Medford, Me., has a variety of active materials including magnetostrictors and shape memory alloys, and their advertising literature and website illustrate such devices, including material specifications and other published details.

FIGS. 1-5 illustrate a typical prior art mold with a side acting insert. As illustrated, the side acting insert is coring a hole in the sidewall of an injection molded part. The mold includes a cavity block 501 and a core block 502 that when closed together form a mold cavity 503 that can be filled with plastic to form a part 504. The mold also includes a side acting insert 505 that has a protruding form 506 that cores a hole 507 in the sidewall of the part 504. In the mold closed position, shown in FIG. 1, the protruding form 506 seals against the side of the core 508 so that the incoming plastic must flow around form 506, thereby shaping the perimeter of the hole 507 in the part. The insert 505 is held against the core by angled pin 509 and angled wall 510 of the mold cavity 501, thereby resisting the force generated by the injection pressure acting on end wall 511 of insert 505 that is urging the insert 505 to move to the left.

After the part has cooled in the closed mold sufficiently the mold is opened. As the cavity block 501 begins to move away from the core block 502 angled pin 509 acts like a cam against the side of the angled through hole 512 in insert 505 causing it to move to the left thereby retracting form 506 from the hole it has cored in the sidewall of the part. Insert 505 is retained on the core block 502 by gibs 513 that allow it to slide horizontally but prevent the insert from being pulled off the core block. The cavity block continues moving away from the core block and as the angled pin 509 loses contact with the side of the angled through hole 512 the insert 505 stops moving to the left. The angle of the pin 509 is designed such that the form 506 will have completely cleared the molded part before the pin 509 loses engagement with the angled hole 512, as shown in FIG. 3. The mold continues to open sufficiently for the part to be ejected, as shown in FIG. 4. The alignment means between the mold halves, the ejection means of the mold, and numerous other details are not shown, as these are well known to those skilled in the art.

FIG. 5 illustrates the effect of wear and misalignment on the side acting insert. When the driving surfaces of the angled pin 509 and/or the angled hole 512 and/or the angled wall 510 of the mold cavity block 501 wear, indicated by the dotted line surfaces 515 and 516 respectively, then the insert form 506 may not seal off properly against the core 508. This usually allows the injected plastic to flash across the hole being cored and partially or completely block it 14 as shown in FIG. 5. Also the wall thickness of the part may be increased below the cored hole 517, as is also shown in FIG. 5. These types of defects are well known in the art when side acting inserts and/or their driving mechanisms wear.

U.S. Pat. No. 4,556,377 to Brown discloses a self-centering mold stack design for thin wall applications. Spring loaded bolts are used to retain the core inserts in the core plate while allowing the core inserts to align with the cavity half of the mold via the interlocking tapers. While Brown discloses a means to improve the alignment between core and cavity and to reduce the effects of core shift (“offset”), there is no disclosure of actually measuring and then correcting such shifting in a proactive manner.

Thus, what is needed is a new technology capable of sealing a side acting mold core insert against a mold core of an injection molding machine. The sealing method and apparatus preferably feature fine levels of adjustable control, and preferably incorporate embedded sensors and closed loop control of the sealing function.

### SUMMARY OF THE INVENTION

It is an advantage of the present invention to provide injection molding machine apparatus and method to overcome the problems noted above, and to provide an effective, efficient means for urging a side core insert against the side wall of the mold core in an injection molding machine.

According to a first aspect of the present invention, structure and/or steps are provided for reducing flash in an injection mold which molds a molded article between a first mold surface and a second mold surface, including an active material actuator configured to, in response to application or removal of an electrical actuation signal thereto, change dimension and urge the first mold surface toward the second mold surface to reduce flash therebetween, and transmission structure configured to provide, in use, the electrical actuation signal to said active material actuator.

According to a second aspect of the present invention, structure and/or steps are provided for a mold half configured to mold an article between said mold half and a complementary mold half, said mold half, including a first mold surface configured to shape the molded article, a piezo-electric actuator configured to urge said first mold surface toward the second mold half, and electrical structure configured to provide an actuation signal to said piezo-electric actuator to cause said piezo-electric actuator to change dimension to urge said first mold surface toward the second mold half.

According to a third aspect of the present invention, structure and/or steps are provided for applying a force to a side acting core insert of a molding machine having a core and a piezoceramic actuator, including the steps of determining a force for sealing a surface of said side acting core insert to a portion of a surface of said core, and actuating said piezoceramic actuator so as to supply said force for sealing said side acting core insert against said core insert.

### BRIEF DESCRIPTION OF THE DRAWINGS

Exemplary embodiments of the presently preferred features of the present invention will now be described with reference to the accompanying drawings in which:

FIG. 1 is a sectional view of a prior art mold with a side acting insert in the mold closed position having been filled with plastic material;

FIG. 2 depicts the mold of FIG. 1 in a partially mold open position with the side acting insert partially retracted;

FIG. 3 depicts the mold of FIG. 1 in a partially mold open position with the side acting insert fully retracted;

FIG. 4 depicts the mold of FIG. 1 in a fully mold open position with the part being ejected;

FIG. 5 is a sectional view of a prior art mold with a side acting insert that has a worn driving mechanism;

FIG. 6 is a sectional view of a first embodiment of the invention in which an active material device compensates for wear and/or misalignment in a side acting insert;

FIG. 7 is a sectional view of a second embodiment of the invention in which active material inserts supply force to slide rails supporting side core inserts, preventing formation of flash on the molded article; and

FIG. 8 is a sectional view of a third embodiment of the invention in which active material inserts supply force directly to side core inserts.

### DETAILED DESCRIPTION OF THE PRESENTLY PREFERRED EXEMPLARY EMBODIMENTS

### 1. Introduction

The present invention will now be described with respect to several embodiments in which a plastic injection-molding machine is supplied with one or more active material elements which serve to urge a side insert against an injection mold core half to produce a molded part having an opening therein. However, the active material sensors and/or actuators may be placed in any location in the injection molding apparatus in which alignment/sealing of parts is desired. Other applications for such active material elements are discussed in the following related applications: (1) U.S. patent application Ser. No. 10/830,434, filed concurrently on Apr. 23, 2004, entitled “Method and Apparatus for Countering Mold Deflection and Misalignment Using Active Material Elements”, (2) U.S. patent application Ser. No. 10/830,403, filed concurrently on Apr. 23, 2004, entitled “Method and Apparatus for Adjustable Hot Runner Assembly Seals and Tip Height Using Active Material Elements”, (3) U.S. patent application Ser. No. 10/830,435, filed concurrently on Apr. 23, 2004, entitled “Method and Apparatus for Assisting Ejection from an Injection Molding Machine using Active Material Elements”, (4) U.S. patent application Ser. No. 10/830,438, filed concurrently on Apr. 23, 2004, entitled “Method and Apparatus for Controlling a Vent Gap with Active Material Elements”, (5) U.S. patent application Ser. No. 10/830,488, filed concurrently on Apr. 23, 2004, entitled “Method and Apparatus for Vibrating Melt in an Injection Molding Machine Using Active Material Elements”, (6) U.S. patent application Ser. No. 10/830,436, filed concurrently on Apr. 23, 2004, entitled “Method and Apparatus for Injection Compression Molding Using Active Material Elements”, and (7) U.S. patent application Ser. No. 10/830,437, filed concurrently on Apr. 23, 2004, entitled “Control System for Utilizing Active Material Elements in a Molding System”.

As discussed above, there is a need in the art for a method and apparatus for locking an object against the side of an injection mold in an injection molding machine in a proactive manner by providing active material means and methods for adjusting the position of the object with respect to the mold core. In the following description, piezoceramic inserts are described as the preferred active material. However, other materials from the active material family, such as magnetostrictors and shape memory alloys could also be used in accordance with the present invention. A list of possible alternate active materials and their characteristics is set forth below in Table 1, and any of these active materials could be used in accordance with the present invention:

TABLE 1
Comparison of Active Materials

| | Temperature | Nonlinearity | Structural | Cost/Vol. | Technical |
|---|---|---|---|---|---|
| Material | Range (° C.) | (Hysteresis) | Integrity | ($/cm3) | Maturity |
| Piezoceramic | −50-250 | 10% | Brittle | 200 | Commercial |
| PZT-5A | | | Ceramic | | |
| Piezo-single | — | <10% | Brittle | 32000 | Research |
| crystal TRS-A | | | Ceramic | | |
| Electrostrictor | 0-40 | Quadratic <1% | Brittle | 800 | Commercial |
| PMN | | | Ceramic | | |
| Magnetostrictor | −20-100 | 2% | Brittle | 400 | Research |
| Terfenol-D | | | | | |
| Shape Memory | Temp. | High | OK | 2 | Commercial |
| Alloy Nitinol | Controlled | | | | |
| Magn. Activated | <40 | High | OK | 200 | Preliminary |
| SMA NiMnGa | | | | | Research |
| Piezopolymer | −70-135 | >10% | Good | 15* | Commercial |
| PVDF | | | | | |

(information derived from www.mide.com)

### 2. The Structure of the First Embodiment

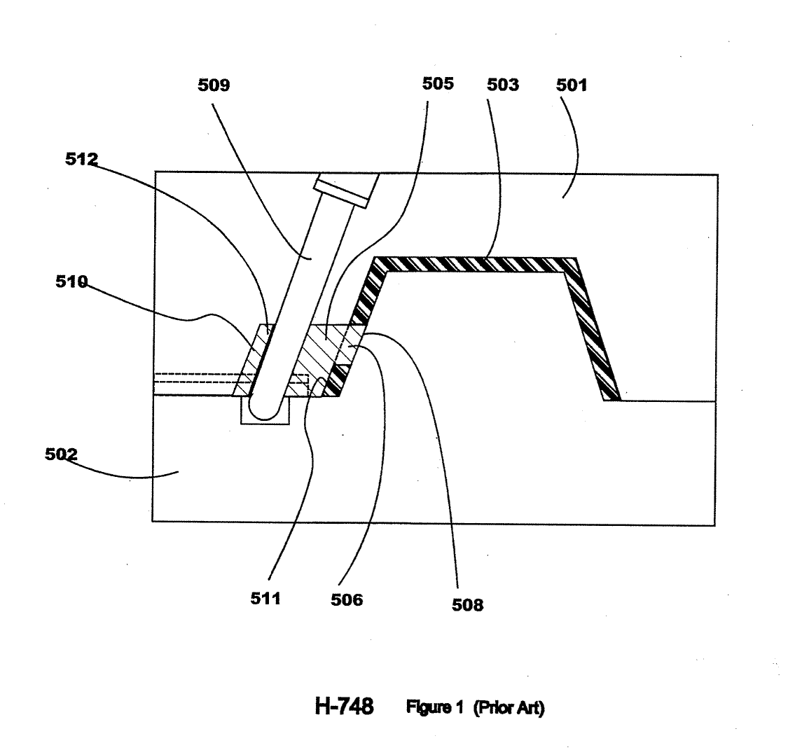

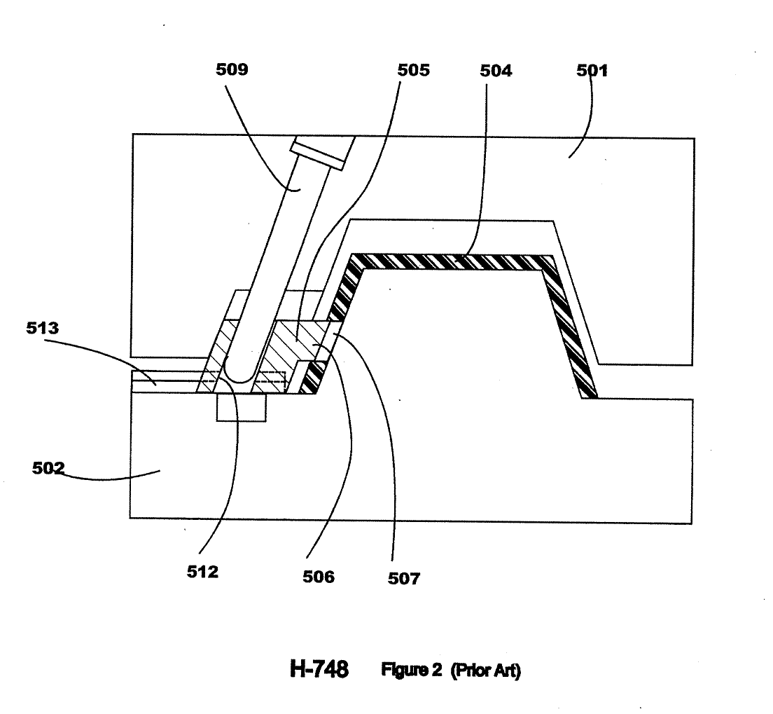

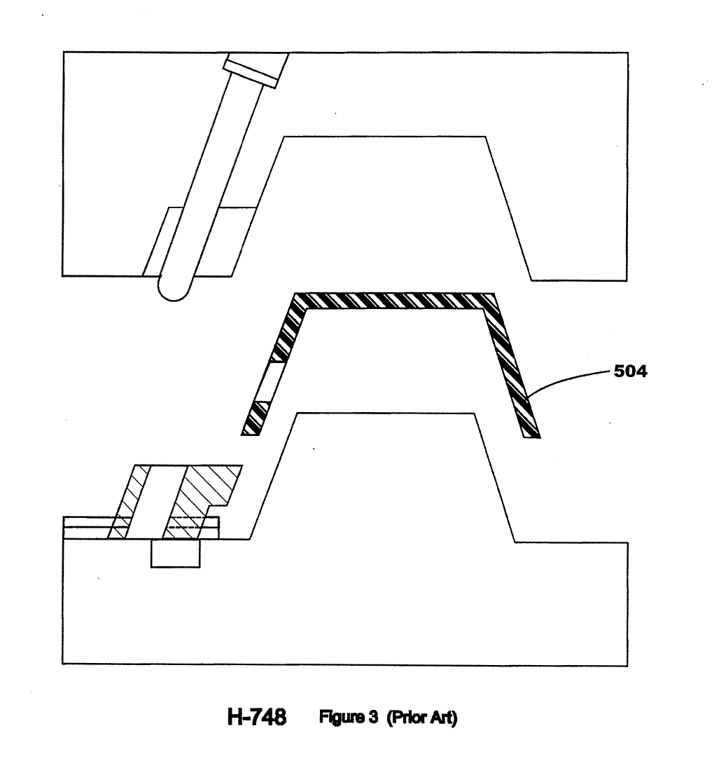

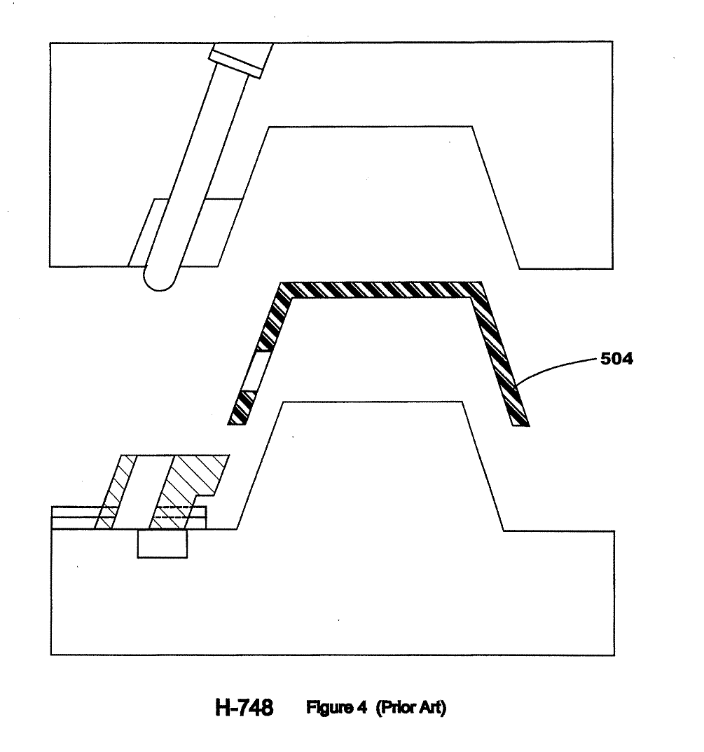

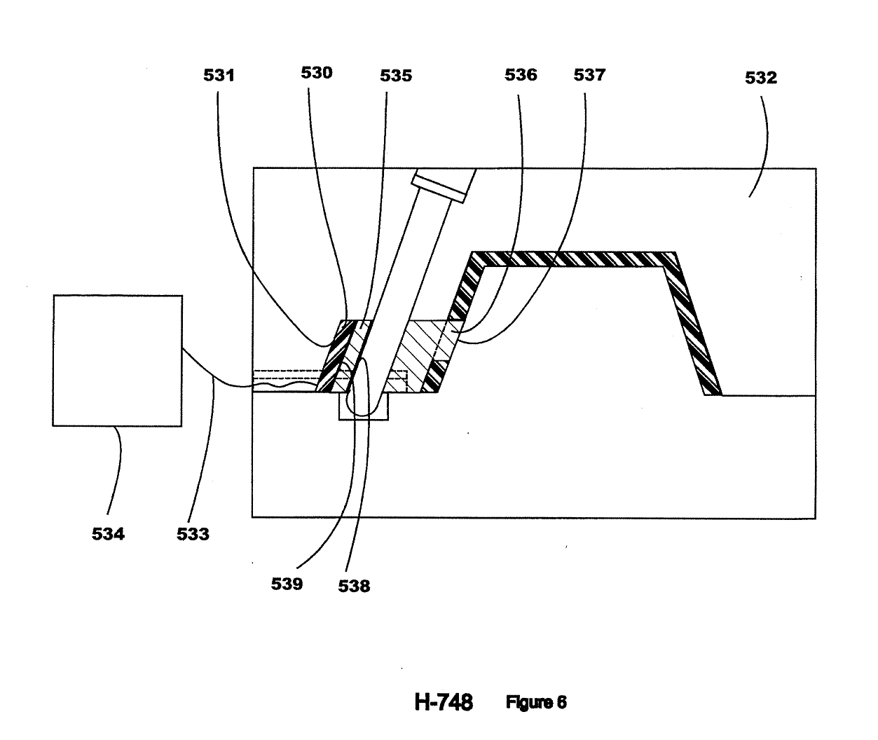

FIG. 6 illustrates a first preferred embodiment of the present invention as applied to the mold shown and described in FIGS. 1-5. A piezoceramic device 530 is attached to a wall of a recess 531 formed in cavity block 532. The piezoceramic device 530 is preferably aligned within the recess 531 so that it is adjacent to a surface of side acting insert 535 within the mold. The piezoceramic device 530 is connected to a controller 534 by a conduit 533, although wireless methods of control are also possible, thereby providing actuation signals to the device 530. The piezoceramic device 530 is oriented such that it expands against the surface of the side acting insert 535, thereby allowing the actuation of the device 530 to press the side acting insert protruding form 536 securely against the core side wall 537. It is also envisioned that the device 530 may be positioned in other locations within the mold assembly, so long as the location allows the actuation of the device to result in the side acting insert 535 being sealingly pressed against core side wall 537.

This first preferred configuration allows the desired hole or opening to be formed precisely within the molded part, regardless of wear of any of the surfaces described above. One or more piezoceramic sensors may also be provided in accordance with this first preferred embodiment of the present invention, along with conduits linking them to the controller 534, in order to obtain a system having closed loop control over the actuation of piezoceramic actuator 530.

The piezoceramic device 530 may comprise one or more piezo-electric sensors and one or more piezo-electric actuators, and may comprise any of the devices manufactured by Marco Systemanalyse und Entwicklung GmbH. The piezo-electric sensor will detect the pressure applied to the device 530 and transmit a corresponding sense signal through the electrical conduit 533. The piezo-electric actuator will receive an actuation signal through the electrical conduit 533 and apply a corresponding force between the side core insert 535 and the core side wall 537.

Note that the piezo-electric sensors may be provided to sense pressure at any desired position. Likewise, more than one piezo-electric actuator may be provided, mounted serially or in tandem, in order to effect extended movement, angular movement, etc. Further, each piezo-electric actuator may be segmented into one or more arcuate, trapezoidal, rectangular, etc., shapes which may be separately controlled to provide varying sealing forces at various locations between the sealing surfaces. Additionally, piezo-electric actuators and/or actuator segments may be stacked in two or more layers to effect fine sealing force control, as may be desired.

The conduits 533 are coupled to any desirable form of controller or processing circuitry for reading the piezo-electric sensor signals and/or providing the actuating signals to the piezo-electric actuators. For example, one or more general-purpose computers, Application Specific Integrated Circuits (ASICs), Digital Signal Processors (DSPs), gate arrays, analog circuits, dedicated digital and/or analog processors, hard-wired circuits, etc., may control or sense the piezo-electric device 530 described herein. Instructions for controlling the one or more processors may be stored in any desirable computer-readable medium and/or data structure, such floppy diskettes, hard drives, CD-ROMs, RAMs, EEPROMs, magnetic media, optical media, magneto-optical media, etc.

Note that the piezo-electric sensors may be provided to sense pressure at any desired position. Likewise, more than one piezo-electric actuator may be provided, mounted serially or in tandem, in order to effect extended movement, angular movement, etc. Further, each piezo-electric actuator may be segmented into one or more arcuate, trapezoidal, rectangular, etc., shapes which may be separately controlled to provide varying sealing forces at various locations between the sealing surfaces. Additionally, piezo-electric actuators and/or actuator segments may be stacked in two or more layers to effect fine sealing force control, as may be desired.

### 3. The Process of the First Embodiment

In operation, device 530 is connected by an electrical conduit 533 to controller 534 such that when the controller energizes the device 530, it expands in width and exerts a force against the angled surface of side core insert 535, thereby urging the insert's protruding form 536 against the core side wall 537. This ensures that a good seal is maintained against the core in spite of any wearing degradation to the surfaces 538 and 539 of the side core insert 535, as previously described. According to the present embodiment, the energizing of device 530 will generate an increase in length of about 0.15% when approximately 1000 V is applied thereto. The actuation of device 530 provides sufficient force (from about 500 kg to about 7000 kg) so that side acting insert 535 and core side wall 537 are sealingly pressed together, thereby ensuring that an effective seal is maintained at the side insert/core side wall interface through a range of molding operation temperatures and pressures. Of course, varying levels of voltage may be applied at various times and to various actuator segments to effect fine control of the sealing force between the various sealing surfaces.

When provided, the sensors may also send signals to the controller 534 to indicate the state of the various mold components, including the piezoceramic device 530. Based on the signals received from the sensors, the controller then generates appropriate actuation signals that are transmitted via conduit 533 to the device 530, energizing it in accordance with the data received from the sensor to accomplish proper sealing of the core insert/core side wall interface. For example, the controller 535 may be programmed to cause the sealing force to remain constant, or to increase and/or decrease according to a predetermined schedule, based on time, temperature, and/or number of cycles. The active material actuator 535 may be used alone or in combination with the angled pin 539.

### 4. The Structure of the Second Embodiment

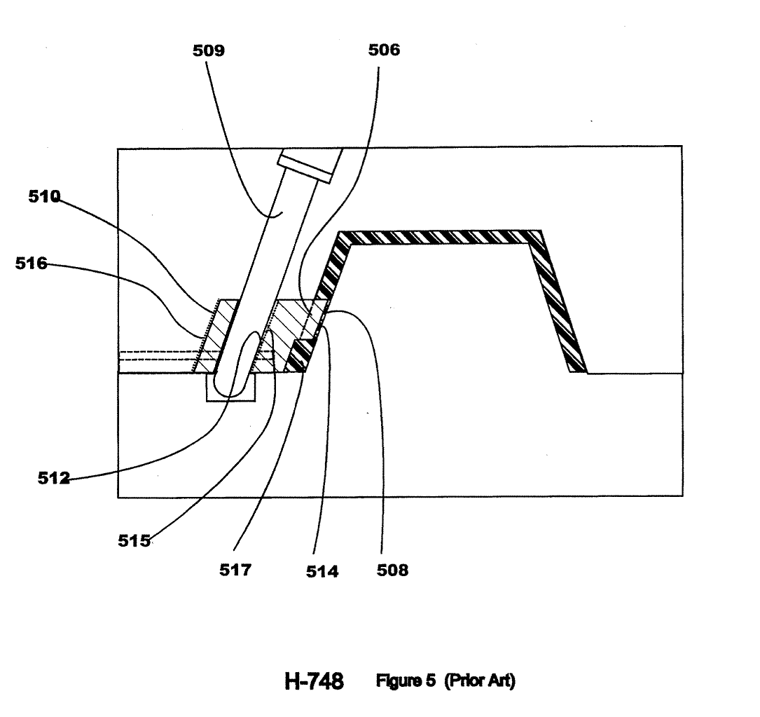

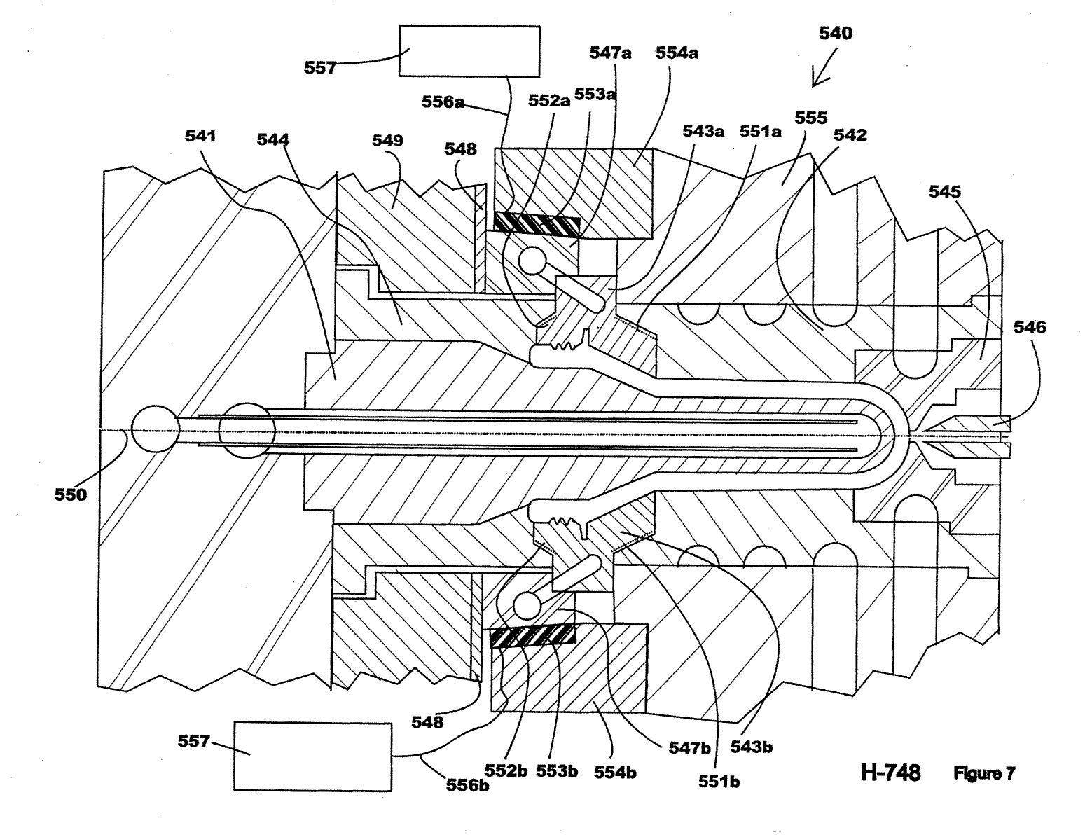

FIG. 7 illustrates a second preferred embodiment of the present invention. A preform mold stack 540 includes a core 541, cavity 542, gate insert 545 with hot runner nozzle 546, and two side core inserts 543a and 543b typically known as neck ring inserts. Each side core insert 543a and 543b is mounted on a movable slide rail 547a and 547b respectively that are retained by gibs (not shown) on a movable stripper plate 549. A wear plate 548 fastened to the stripper plate 549 provides a suitable surface on which the side core inserts slide. The slide rails 547a and 547b, and consequently the side core inserts 543a and 543b mounted thereon, are moved perpendicularly with respect to the center axis of the stack 550 by cams (not shown) in a conventional manner during the ejection portion of the molding cycle. The taper locking surfaces 551a, 552a and 551b, 552b, respectively, of the side core inserts 543a and 543b wear as previously described with respect to FIG. 5. Piezoceramic insert devices 553a and 553b are mounted in recesses formed in support blocks 554a and 554b that are fastened to the cavity plate 555. The devices are electrically connected via conduits 556a and 556b, respectively, to a single controller 557 (shown here in two places for convenience).

Again, according to an optional embodiment of the second embodiment, one or more piezoceramic sensors may be provided along with wiring connecting them to the control means, in order to obtain real time closed loop control over the locking mechanism for side core inserts provided herein. The piezo-electric elements used in accordance with the present invention (i.e., the piezo-electric sensors and/or piezo-electric actuators) may comprise any of the devices manufactured by Marco Systemanalyse und Entwicklung GmbH. Note that piezo-electric sensors may be provided to sense pressure from any desired position. Likewise, more than one piezo-electric actuator may be provided in place of any single actuator described herein, and the actuators may be mounted serially or in tandem, in order to effect extended movement, angular movement, etc.

As mentioned above, one of the significant advantages of using the above-described active element inserts is to allow the manufacturing tolerances used for the side acting insert, mold core, and mold cavity to be widened, thereby significantly reducing the cost of machining those features in the mold components.

### 5. The Process of the Second Embodiment

In operation, when the mold is closed and clamped, the piezoceramic insert devices 553a and 553b are energized by the controller 557 to exert an additional force acting on the slide rails 547a and 547b, respectively. This increases the force clamping together the side core inserts 543a and 543b mounted thereon, thereby generally minimizing the risk of flash being formed on the molded part formed therebetween. According to the present embodiment, the energizing of elements 553a and 553b preferably will generate an increase in length in each element of about 0.15% when approximately 1000 V is applied thereto. The actuation of elements 553a and 553b provides sufficient force (from about 500 kg to about 10,000 kg) to ensure that effective seals are maintained at the junctions within the mold assembly throughout a range of operating temperatures.

The additional use of sensors, when provided, allows for automatic control of the piezoceramic devices 553a and 553b. The controller can, for example, use signals from piezoceramic sensors within the injection molding machine to determine when the actuators should be activated and deactivated during the molding cycle on a real-time basis. The sensor elements generate signals in response to pressure between various interfaces within the injection mold, and transmit the signals via conduits to the controllers. Based on the signals received from the sensors, the controller then generates other signals that are transmitted via conduits to the actuators, energizing them in accordance with the data received from the sensors to accomplish proper sealing of the side acting insert/mold core side wall interface.

### 6. The Structure of the Third Embodiment

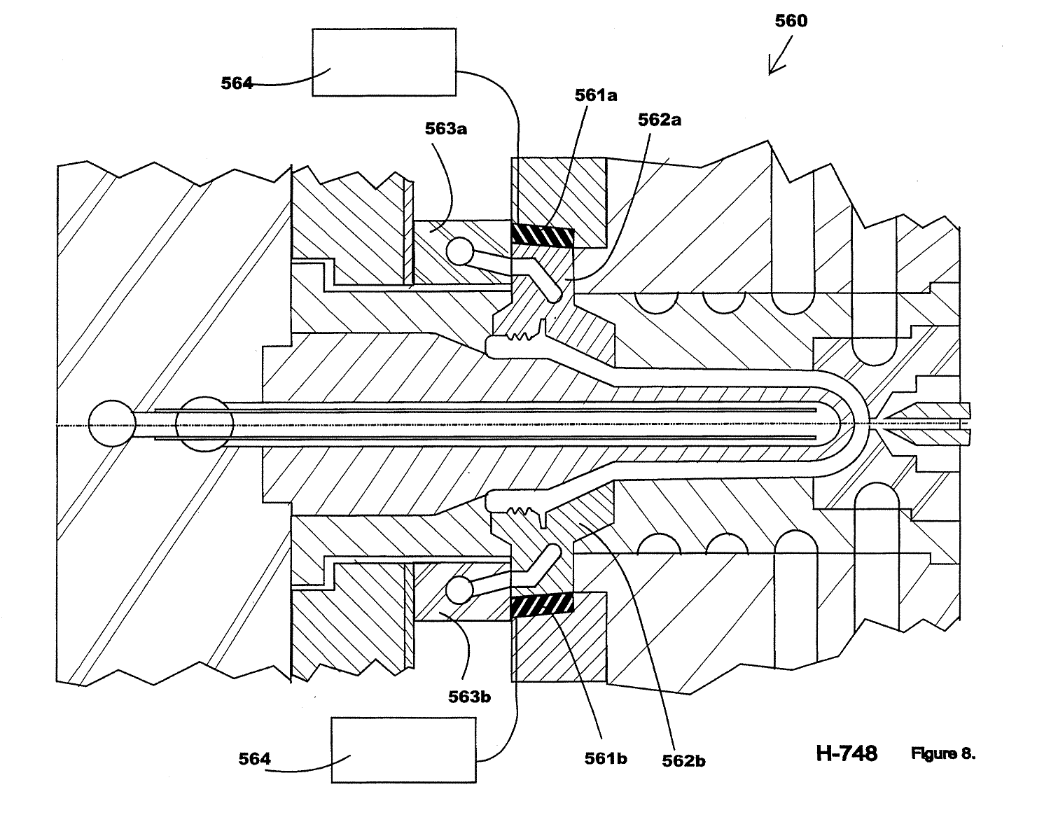

FIG. 8 shows a third preferred embodiment of the present invention. The preform mold stack 560 is similar to that shown in FIG. 7, but differs in that the piezoceramic insert devices 561a and 561b are positioned to apply a force directly against each side core insert 562a and 562b, respectively, instead of against the slide rails 563a and 563b, as is the case in the embodiment shown in FIG. 7. This means that in this embodiment each pair of side core inserts 562a and 562b can be directly acted upon by its own pair of piezoceramic inserts 561a and 561b. When the present embodiment is implemented in a multi-cavity injection mold, the controller 564 may be programmed to provide individual signals to activate each pair of piezoceramic inserts, thereby allowing each molding stack to be “tuned”. Thus, if molded parts are found to contain parting line flash that varies between the molding stacks in the mold, each unique variation can be individually remedied by programming the controller to adjust the clamping force applied to the respective side core inserts.

Again, as in the first and second preferred embodiments of the present invention, sensors may be provided within the mold stacks and connected to the controller if closed loop feedback control over the force applied to the side core inserts is desired.

### 7. The Process of the Third Embodiment

In operation, the embodiment shown in FIG. 8 is similar to that of the embodiment of FIG. 7, but may be used in situations where it is desirable to provide more clamping force to the side core inserts that may be desirable in heavy duty, higher pressure molding operations. When the mold is closed and clamped, the piezoceramic insert devices 553a and 553b are energized by the controller 557 to exert an additional force acting directly on the side core inserts 543a and 543b, thereby minimizing the risk of flash being formed on the molded part formed therebetween.

The additional use of sensors, when provided, allows for automatic control of the piezoceramic devices 553a and 553b. The controller can, for example, use signals from piezoceramic sensors within the injection molding machine to determine when the actuators should be activated and deactivated during the molding cycle on a real-time basis.

The additional piezoceramic elements acting as sensors are used in combination with the actuators to provide closed loop feedback control of the piezoceramic devices 553a and 553b. The sensor elements generate signals in response to pressure between the various components of the mold, and transmit a corresponding signal via conduits to the controller 557. Based on the signals received from the sensors, the controller 557 then generates actuation signals that are transmitted via conduits to the actuator elements, energizing them in accordance with the data received from the sensors to accomplish proper sealing of the side core insert and mold core side wall interface.

### 8. Conclusion

Thus, what has been described is a method and apparatus for using piezo-ceramic elements in an injecting molding machine, separately and in combination, to effect useful improvements in injection molding apparatus, and particularly in the clamping of side core inserts to their respective mold cores.

Advantageous features according the present invention include: 1. A piezo ceramic element used singly or in combination to generate a force on a surface of a mold component in an injection molding apparatus. 2. The provision of force via active material elements to the surface of mold components in a manner that is tailored to the specific forces required by the mold stack, particularly a mold stack in a multi-stack molding apparatus, where each stack requires individualized force application. 3. An injection mold provided with at least an active material actuator for compressing one or more side core inserts against a mold core, optionally including a closed loop control system.

While the present invention provides distinct advantages for injection-molded PET plastic preforms generally having circular cross-sectional shapes perpendicular to the preform axis, those skilled in the art will realize the invention is equally applicable to other molded products, possibly with non-circular cross-sectional shapes, such as, pails, paint cans, tote boxes, and other similar products. All such molded products come within the scope of the appended claims.

The individual components shown in outline or designated by blocks in the attached Drawings are all well-known in the injection molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents discussed above (and particularly the applications discussed above in paragraph [0022]) are hereby incorporated by reference into the Detailed Description of the Preferred Embodiment.

What is claimed is:

1. A method of assembling mold components in a molding machine, comprising the steps of:
positioning said plurality of active material actuators adjacent to mold components which are to be urged toward other mold components;
positioning said plurality of sensors to detect pressure between the mold components and the other mold components;
configuring said plurality of sensors to detect pressure between said mold components and said other mold components, and to transmit to a controller, in use, sense signals corresponding to the detected pressures.
